(19) United States
(12) Patent Application Publication
(10) Pub. No.: US 2022/0414685 A1
(43) Pub. Date: Dec. 29, 2022

(54) METHOD AND SYSTEM FOR INTERPRETING CUSTOMER BEHAVIOR VIA CUSTOMER JOURNEY EMBEDDINGS

(71) Applicant: JPMorgan Chase Bank, N.A., New York, NY (US)

(72) Inventors: Simran LAMBA, Jersey City, NJ (US); Vamsi Krishna POTLURU, New York, NY (US); Maria Manuela VELOSO, New York, NY (US); Prashant P REDDY, Madison, NJ (US)

(73) Assignee: JPMorgan Chase Bank, N.A., New York, NY (US)

(21) Appl. No.: 17/359,076

(22) Filed: Jun. 25, 2021

(51) Int. Cl. G06Q 30/02; G06Q 30/00; G06N 3/04; G06N 3/08; G06F 16/31; G06F 40/279

(52) U.S. Cl. CPC G06Q 30/0201; G06Q 30/016; G06N 3/04; G06N 3/088; G06F 16/313; G06F 40/279; G06Q 30/0269

(57) ABSTRACT

A method and a system for generating an interpretable embedding that corresponds to a sequence of events is provided. The method includes: receiving information that corresponds to a sequence of events that respectively correspond to interactions between a customer and an organization; determining, for each respective event, a respective product associated with the organization and a respective channel via which the event has occurred; assigning a respective sentiment to each event; computing a respective weight for each event; aggregating the computed weights with respect to the products and the channels; and using the aggregated weights to generate the interpretable embedding for the customer. The interpretable embedding is then usable for generating targeted offers to the customer, handling complaints, and preventing subsequent complaints.

### BACKGROUND

### 1. Field of the Disclosure

This technology generally relates to methods and systems for understanding and interpreting interactions between a customer and a business, and more particularly to methods and systems for learning customer journey embeddings by which event sequences are analyzed for understanding and interpreting customer behavior.

### BACKGROUND INFORMATION

Businesses use a wide range of channels to communicate about the different products and services they offer to their customers. These touchpoints are logged as customer journeys. Customer journeys can be represented as temporal sequences of events occurring at irregular time intervals. Examples of such data include customers' e-commerce browsing and/or purchase history, and customers' interactions with a bank Each event sequence can consist of multiple events of different types. For example, with respect to a bank, customers could interact with the various products such as home mortgage, auto loan, credit cards across many different channels such as call agents, automatic teller machines (ATMs), and mobile and web applications. Learning intermediate representations of these customer journeys can help banks better understand customer behavior in order to deepen the relationship with clients, offer targeted services (marketing), prevent or handle complaints (operations).

Recently, such sequences have been modeled using recurrent neural networks (RNNs), especially long short-term memory (LSTM) and gated recurrent units (GRU). However, despite high accuracy, RNNs fall short of interpretability due to their opaque hidden states. While there have been several attempts at directly interpreting RNNs, these methods are not sufficiently developed for application in finance and e-commerce because they ignore the rich semantic information that is available in the events corresponding to the customer journeys.

Accordingly, there is a need for a capability to learn interpretable embeddings of these rich customer journeys which summarize the event sequences to current states of the customers for each product and channel intersection, and to train the learned interpretable customer journey embeddings for downstream supervised marketing and operations tasks.

### SUMMARY

The present disclosure, through one or more of its various aspects, embodiments, and/or specific features or sub-components, provides, inter alia, various systems, servers, devices, methods, media, programs, and platforms for learning customer journey embeddings by which event sequences are analyzed for understanding and interpreting customer behavior.

According to an aspect of the present disclosure, a method for generating an interpretable embedding that corresponds to a sequence of events is provided. The method is implemented by at least one processor. The method includes: receiving, by the at least one processor, information that corresponds to a plurality of events that respectively correspond to interactions between a customer and an organization; determining, by the at least one processor for each respective event from among the plurality of events, a respective product associated with the organization that relates to the respective event and a respective channel associated with the organization via which the respective event has occurred; assigning, by the at least one processor, a respective sentiment to each respective event from among the plurality of events; computing, by the at least one processor, a respective weight for each respective event from among the plurality of events; aggregating, by the at least one processor, the computed respective weights with respect to the determined products and the determined channels; and using, by the at least one processor, the aggregated weights to generate the interpretable embedding for the customer.

The method may further include generating a targeted offer to the customer based on the generated interpretable embedding.

When at least one event from among the plurality of events includes a customer complaint, the method may further include using the generated interpretable embedding to generate a response to the customer complaint.

When at least two events from among the plurality of events include customer complaints, the method may further include using the generated interpretable embedding to reduce a frequency of subsequent customer complaints.

The assigning of a respective sentiment may include tagging the respective event as being one from among a positive event, a negative event, and a neutral event.

The assigning of the respective sentiment may further include extracting at least one keyword from the respective event and comparing the extracted at least one keyword with each of a first list of keywords associated with a positive event, a second list of keywords associated with a negative event, and a third list of keywords associated with a neutral event.

The computing of the respective weight may include using a term frequency inverse document frequency (tf-idf) algorithm to compute the respective weight.

The computing of the respective weight may include using a feed-forward artificial neural network architecture that includes a plurality of perceptron layers to compute the respective weight.

The computing of the respective weight may further include adding at least one hidden layer that uses Rectified Linear Unit (ReLu) that indicates intersections of the determined products and the determined channels to the feed-forward artificial neural network.

According to another exemplary embodiment, a computing apparatus for generating an interpretable embedding that corresponds to a sequence of events is provided. The computing apparatus includes a processor; a memory; and a communication interface coupled to each of the processor and the memory. The processor is configured to: receive, via the communication interface, information that corresponds to a plurality of events that respectively correspond to interactions between a customer and an organization; determine, for each respective event from among the plurality of events, a respective product associated with the organization that relates to the respective event and a respective channel associated with the organization via which the respective event has occurred; assign a respective sentiment to each respective event from among the plurality of events; compute a respective weight for each respective event from among the plurality of events; aggregate the computed respective weights with respect to the determined products and the determined channels; and use the aggregated weights to generate the interpretable embedding for the customer.

The processor may be further configured to generate a targeted offer to the customer based on the generated interpretable embedding.

When at least one event from among the plurality of events includes a customer complaint, the processor may be further configured to use the generated interpretable embedding to generate a response to the customer complaint.

When at least two events from among the plurality of events include customer complaints, the processor may be further configured to use the generated interpretable embedding to reduce a frequency of subsequent customer complaints.

The processor may be further configured to assign the respective sentiment by tagging the respective event as being one from among a positive event, a negative event, and a neutral event.

The processor may be further configured to extract at least one keyword from the respective event and compare the extracted at least one keyword with each of a first list of keywords associated with a positive event, a second list of keywords associated with a negative event, and a third list of keywords associated with a neutral event.

The processor may be further configured to use a term frequency inverse document frequency (tf-idf) algorithm to compute the respective weight.

The processor may be further configured to use a feed-forward artificial neural network architecture that includes a plurality of perceptron layers to compute the respective weight.

The processor may be further configured to add at least one hidden layer that uses Rectified Linear Unit (ReLu) that indicates intersections of the determined products and the determined channels to the feed-forward artificial neural network.

According to yet another exemplary embodiment, a non-transitory computer readable storage medium storing instructions for generating an interpretable embedding that corresponds to a sequence of events is provided. The storage medium includes executable code which, when executed by a processor, causes the processor to: receive information that corresponds to a plurality of events that respectively correspond to interactions between a customer and an organization; determine, for each respective event from among the plurality of events; a respective product associated with the organization that relates to the respective event and a respective channel associated with the organization via which the respective event has occurred; assign a respective sentiment to each respective event from among the plurality of events; compute a respective weight for each respective event from among the plurality of events; aggregate the computed respective weights with respect to the determined products and the determined channels; and use the aggregated weights to generate the interpretable embedding for the customer.

The executable code may be further configured to cause the processor to assign a respective sentiment to each respective event by tagging the respective event as being one from among a positive event, a negative event, and a neutral event.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for learning customer journey embeddings by which event sequences are analyzed for understanding and interpreting customer behavior,

FIG. 4 is a flowchart of an exemplary process for implementing a method for learning customer journey embeddings by which event sequences are analyzed for understanding and interpreting customer behavior.

FIG. 5 is a graphical depiction of an interpretable embedding of a customer that registered a complaint that is generated as an output of a method for learning customer journey embeddings by which event sequences are analyzed for understanding and interpreting customer behavior, according to an exemplary embodiment.

FIG. 6 is a graphical depiction of a comparison between a windowing process as applied to a customer journey without interpretability and a windowing process as applied to a customer journey with interpretability, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

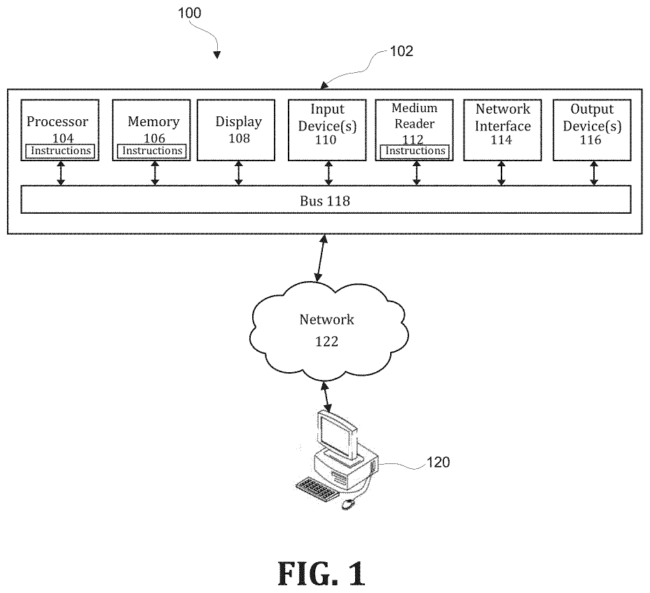

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both, Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (MED), a flat panel display, a solid state display, a cathode ray tube (CRT), a plasma display, or any other type of display; examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (UPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for learning customer journey embeddings by which event sequences are analyzed for understanding and interpreting customer behavior.

Referring to NG. 2, a schematic of an exemplary network environment 200 for implementing a method for learning customer journey embeddings by which event sequences are analyzed for understanding and interpreting customer behavior is illustrated. In an exemplary embodiment, the method is executable on any networked computer platform, such as, for example, a personal computer (PC).

The method for learning customer journey embeddings by which event sequences are analyzed for understanding and interpreting customer behavior may be implemented by a Customer Journey Embeddings Interpretation (CJEI) device 202. The CJEI device 202 may be the same or similar to the computer system 102 as described with respect to FIG. 1. The CJEI device 202 may store one or more applications that can include executable instructions that, when executed by the CJEI device 202, cause the CJEI device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CJEI device 202 itself, may be located in virtual server(s) running in a cloud-based computing environment rather than being tied to one or more specific physical network computing devices. Also, the application(s) may be running in one or more virtual machines (VMs) executing on the CJEI device 202. Additionally in one or more embodiments of this technology, virtual machine(s) running on the CJEI device 202 may be managed or supervised by a hypervisor.

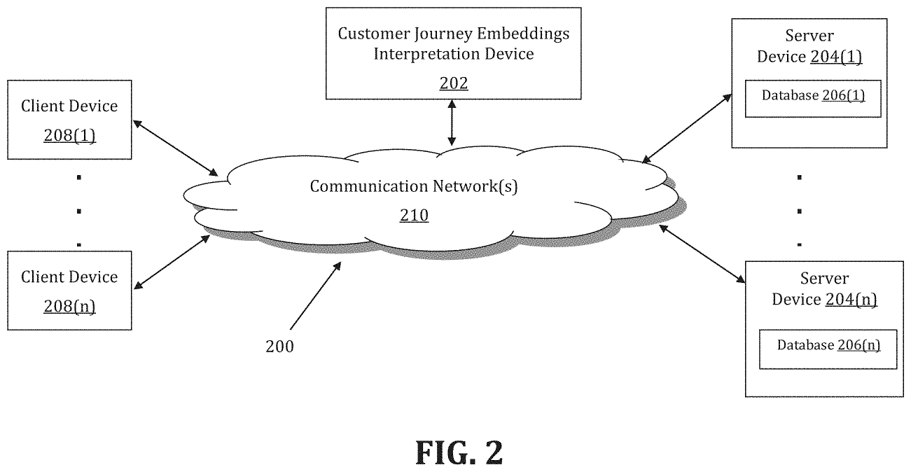

In the network environment 200 of FIG. 2, the CJEI device 202 is coupled to a plurality of server devices 204(1)-204(n) that hosts a plurality of databases 206(1)-206(n), and also to a plurality of client devices 208(1)-208(n) via communication network(s) 210. A communication interface of the CJEI device 202, such as the network interface 114 of the computer system 102 of FIG. 1, operatively couples and communicates between the CJEI device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OH device 202, the server devices 204(1)-204(n), and/or the client devices 208(1)-208(n) may be coupled together via other topologies. Additionally, the network environment 200 may include other network devices such as one or more routers and/or switches, for example, which are wel known in the art and thus will not be described herein. This technology provides a number of advantages including methods, non-transitory computer readable media, and CJEI devices that efficiently implement a method for learning customer journey embeddings by which event sequences are analyzed for understanding and interpreting customer behavior.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CJEI device 202 may be a standalone device or integrated with one or more other devices or apparatuses, such as one or more of the server devices 204(1)-204(n), for example. In one particular example, the CJEI device 202 may include or be hosted by one of the server devices 204(1)-204(n), and other arrangements are also possible. Moreover, one or more of the devices of the CJEI device 202 may be in a same or a different communication network including one or more public, private, or cloud networks, for example.

The plurality of server devices 204(1)-204(n) may be the same or similar to the computer system 102 or computer device 120 as described with respect to MG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MNLP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to customer events and interactions and machine learning algorithms for interpreting customer journey data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CJEI device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CJEI device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CJEI device 202, the server devices 204(1)-204(n), or the client devices 208(1)-208(n), for example, may be configured to operate as virtual instances on the same physical machine. In other words, one or more of the CJEI device 202, the server devices 204(1)-204(n), or the client devices 208(1)-208(n) may operate on the same physical device rather than as separate devices communicating through communication network(s) 210. Additionally, there may be more or fewer CJEI devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks. Packet Data Networks (PDNs), the Internet, intranets, and combinations thereof.

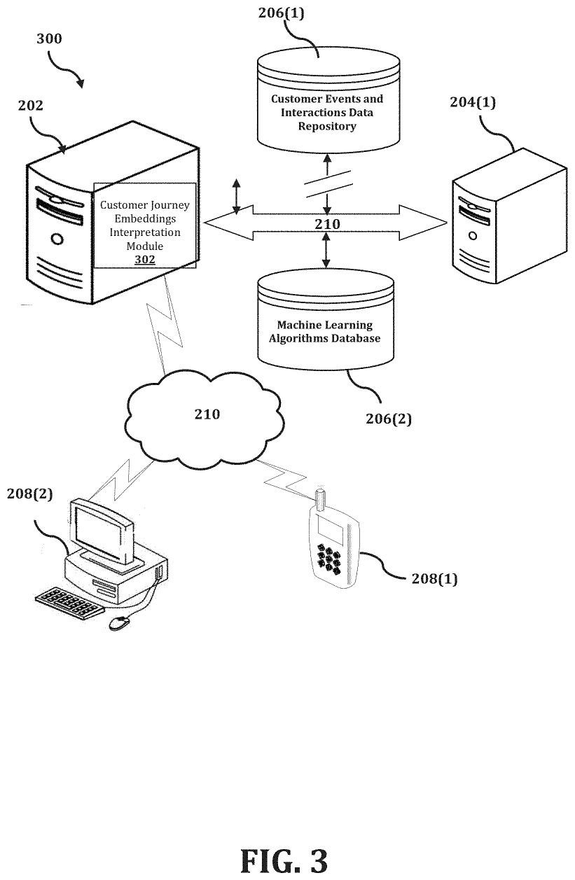

The CJEI device 202 is described and illustrated in FIG. 3 as including a customer journey embeddings interpretation module 302, although it may include other rules, policies, modules, databases, or applications, for example. As will be described below, the customer journey embeddings interpretation module 302 is configured to implement a method for learning customer journey embeddings by which event sequences are analyzed for understanding and interpreting customer behavior.

An exemplary process 300 for implementing a mechanism for learning customer journey embeddings by which event sequences are analyzed for understanding and interpreting customer behavior by utilizing the network environment of FIG. 2 is illustrated as being executed in FIG. 3. Specifically, a first client device 208(1) and a second client device 208(2) are illustrated as being in communication with CM device 202. In this regard, the first client device 208(1) and the second client device 208(2) may be “clients” of the CJEI device 202 and are described herein as such. Nevertheless, it is to be known and understood that the first client device 208(1) and/or the second client device 208(2) need not necessarily be “clients” of the CJEI device 202, or any entity described in association therewith herein. Any additional or alternative relationship may exist between either or both of the first client device 208(1) and the second client device 208(2) and the CID device 202, or no relationship may exist.

Further, CJEI device 202 is illustrated as being able to access a customer events and interactions data repository 206(1) and a machine learning algorithms database 206(2). The customer journey embeddings interpretation module 302 may be configured to access these databases for implementing a method for learning customer journey embeddings by which event sequences are analyzed for understanding and interpreting customer behavior.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CJEI device 202 via broadband or cellular communication, Of course, these embodiments are merely exemplary and are not limiting or exhaustive.

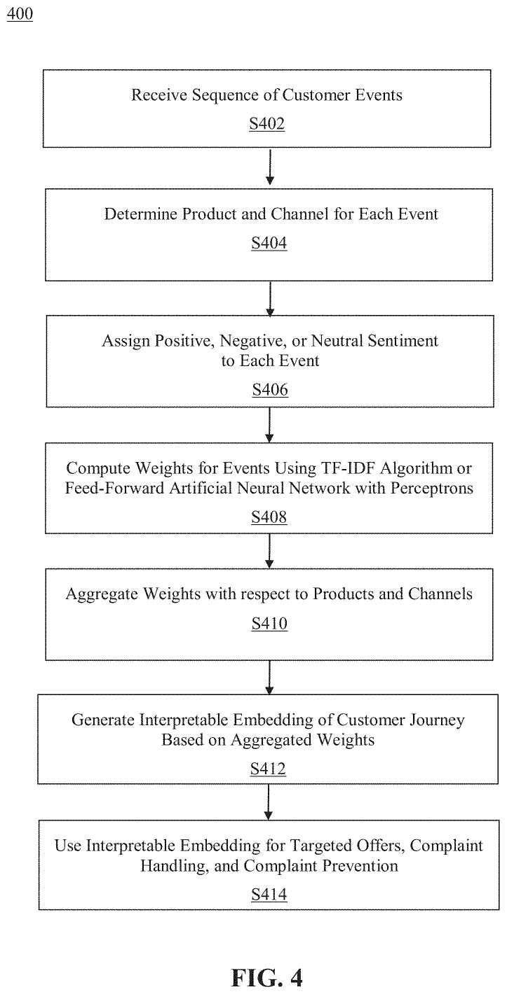

Upon being started, the customer journey embeddings interpretation module 302 executes a process for learning customer journey embeddings by which event sequences are analyzed for understanding and interpreting customer behavior. An exemplary process for learning customer journey embeddings by which event sequences are analyzed for understanding and interpreting customer behavior is generally indicated at flowchart 400 in FIG. 4.

In process 400 of FIG. 4, at step S402, the customer journey embeddings interpretation module 302 receives information that corresponds to a sequence of events and/or interactions between a customer and an organization. In an exemplary embodiment, the organization is a financial institution, such as, example, a bank; however, in other exemplary embodiments, the organization may be other types of entities, such as a health care institution or another type of commercial entity. The events included in the sequence may include various types of interactions. For example, when the organization is a bank; the events may include interactions such as a funds transfer, a funds withdrawal, a credit application approval, a customer service call, a retrieval of a transaction summary, a card verification, a withdrawal error, a denial of a request due to a fraud alert, and/or any other type of interaction between a customer and a bank. For other types of organizations, the sequence of events may include other types of events that are relevant to the organization's line of business.

At step S404, the customer journey embeddings interpretation module 302 determines a product and a channel of interaction for each event included in the sequence of events. For the example in which the organization is a bank, the product types may include payment cards, such as credit cards and/or debit cards; mortgage loans; automobile loans; and banking products. The channels of interaction for a bank may include an automatic teller machine (ATM); a payment mechanism; a card agent; a mobile application; an alerts mechanism; a complaint registration; a fee mechanism; a dispute mechanism; a claim mechanism; a banker; a retail agent; a web network (e.g., the Internet); a retail interactive voice response (IVR) mechanism; a mortgage IVR mechanism; and/or a fraud mechanism.

At step S406, the customer journey embeddings interpretation module 302 assigns a sentiment to each event included in the event sequence. In an exemplary embodiment, the sentiment is selected from among a positive sentiment, a negative sentiment, or a neutral sentiment. The assignment of the sentiment may be implemented by tagging each event by using keyword matching between words included in the event and words included in respective lists that are associated with positive, negative, and neutral sentiments.

At step S408, the customer journey embeddings interpretation module computes a weight for each event included in the event sequence. In an exemplary embodiment, a unsupervised approach to weight computation may be implemented by using a term frequency inverse document frequency algorithm to compute each weight. In this context, term frequency is defined as the number of times that an event is observed for a particular customer within the sequence of events, and inverse document frequency is defined as a logarithmically scaled inverse fraction of customer journeys that contain the event.

Alternatively, a supervised approach to the weight computation may be implemented by using a deep learning technique that implements an architecture of feed-forward artificial neural networks (ANN) that include multiple layers of perceptrons, also referred to herein as dense nodes. A more detailed discussion of this approach is provided below.

At step S410, the customer journey embeddings interpretation module 302 aggregates the computed weights for all events with respect to both products and channels. Then, at step S412, the interpretable embeddings are generated for the particular customer based on the aggregations.

At step S414, the interpretable embeddings may be used for various purposes, such as marketing purposes and/or operational purposes. For example, the interpretable embeddings may facilitate the generation of a targeted offer to be provided to the customer. As another example, when the sequence of events includes one or more complaints, the interpretable embeddings may facilitate the handling of an unresolved complaint and/or prevention of subsequent complaints, thereby reducing a frequency of complaints from that customer in the future. In addition to targeted offers/advertisements and customer complaints, the interpretable embeddings may potentially encompass a wide variety of possible indications based on the event sequence, such as, for example, instance collections. As another example, in the health care domain, when the sequence of events includes patient symptoms, this may correspond to an interpretable embedding that indicates a higher level organ failure and/or a disease classification.

In an exemplary embodiment, interpretable embeddings of rich customer journeys which summarize event sequences to current states of customers for each product and channel intersection are learned. These may be referred to as customer journey embeddings (CJE), The learned interpretable customer journey embeddings can be further trained for downstream supervised marketing and operations tasks. In particular, the contribution is twofold: 1) Interpretable embeddings of customer journeys are learned by using both an unsupervised method of term frequency—inverse document frequency (tf-idf) and a supervised method of feed-forward networks. These can be computed at any point in time for a given customer for all given products and channels. 2) Evaluation of the learned embeddings as an input feature for an operations prediction task for a demonstrated superior performance.

Problem Formulation: In an exemplary embodiment, the business is a bank, and the customers are customers of the bank. The starting point is a collection of N customer journey sequences C={cⁿ}ₙ₌₁^{N} such that cⁿ={(eᵢ,tᵢ)}ₗ₌₁^{M}^{ₙ} is the set of events (with time-stamp t₁ and event types eᵢ∈={E₁, . . . ,E_{d})} observed so far. Each event E is categorized by the channel and product of interaction. Table 1 and Table 2 show the product and channel categories available respectively in the bank's customer journeys dataset. Table 3 shows events that are sorted based on sentiments assigned thereto.

In an exemplary embodiment, given a customer journey Cₙ, an objective is to learn an interpretable low dimensional vector representation vₙ at time T. The loss function optimized to learn these embeddings is known as the Binary Cross Entropy/Log Loss function.

TABLE 1
Products
Card
Mortgage
Auto
banking

TABLE 2
Channels

| | | |
|---|---|---|
| atm | payments | card agent |
| mobile | Alerts | complaint |
| fee | Dispute | claim |
| banker | retail agent | web |
| retail ivr | mortgage ivr | fraud |

TABLE 3
Events

| | Examples of | | Number of |
|---|---|---|---|
| Sentiment | keywords matched | Examples of events | events |
| Positive | completed, approved, | mortgage: application | 200 |
| | refund | status approved, web: | |
| | | funds transfer | |
| | | completed | |
| Negative | error, unsuccessful, | atm: withdrawal | 928 |
| | decline, fee, dispute, | error, retailposdecline: | |
| | failure, denied, | fraud rule decline | |
| | complained | | |
| Neutral | — | mobile: transaction | 1400 |
| | | summary, card ivr: | |
| | | card verification | |

Methodology: In an exemplary embodiment, an unsupervised method of tf-idf and a supervised method of feed-forward networks for learning interpretable embeddings of customer journeys are proposed. First, a sentiment is assigned to each event using the approach of tagging. The sentiment may be positive, negative, or neutral. The idea is to learn an embedding for each of category of events that corresponds to the products of Table 1 and the channels of Table 2. Depending on the downstream supervised task, these embeddings can be weighted differently according to the business logic. Windowing may be used to model the temporal sequences. In case of tf-idf embedding, the event weights are aggregated over products and channels of interaction to achieve interpretability, To facilitate a deep learning approach, a sparse hidden layer is added before the output layer to make the embedding interpretable.

Tagging: Each event E is tagged as positive, negative or neutral. Automatic tagging of negative and positive events may be implemented by using keyword matches. Table 3 contains examples of events and keywords searched to tag those events for each category. For the neutral category, the set of positive and negative events may be removed from the set of all events E.

Windowing: In an exemplary embodiment, a sliding window approach may be applied in order to generate subsequences. The choice of the windows may either be overlapping or non-overlapping and the size of the windows can be informed by business domain knowledge. For example, when a term frequency inverse document frequency (tf-idf) approach is used, non-overlapping windows may be used. In an experimental results section below, window sizes of 1 week, 1 month and 3 months for the ti-idf approach are compared. When a deep learning approach is used, a non-overlapping window of size one month may be used. Alternative approaches may include modeling these sequences as point processes.

Aggregating: In an exemplary embodiment, for the tf-idf approach, the embedding weights may be summed over product and channel of interactions, thus resulting in an interpretable representation with products and channels as its dimensions. In the context of negative events, the resulting representation can be interpreted as how dissatisfied a customer is with a specific product channel intersection. Similarly, for positive events, the embedding can be explained as customer satisfaction for a given product and channel.

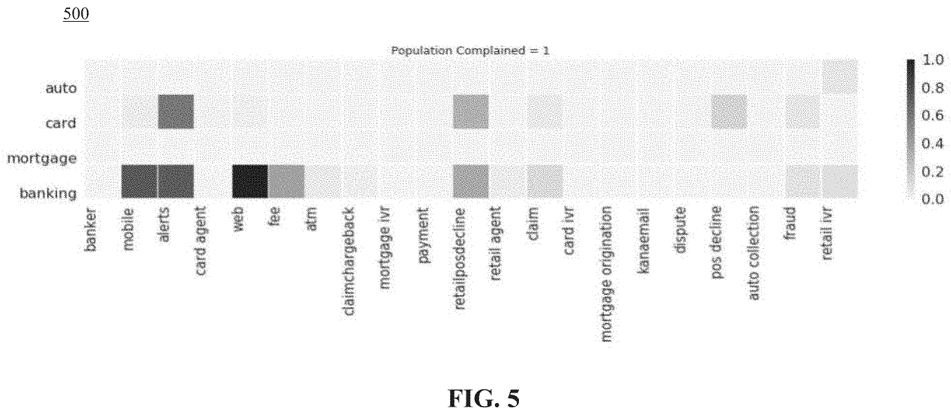

FIG. 5 is a graphical depiction 500 of an interpretable embedding of a customer that registered a complaint that is generated as an output of a method for learning customer journey embeddings by which event sequences are analyzed for understanding and interpreting customer behavior, according to an exemplary embodiment.

Referring to FIG. 5, an example of interpretable tf-idf embedding of a bank customer who complained is illustrated. The graph 500 has channels of interaction on the x-axis and products on the y-axis. The embedding results in a weight for each product-channel intersection, and the weights are normalized to a scale of between zero and one (0.0-1.0). In the context of negative events, a higher weight and a darker color corresponds with a greater degree of customer dissatisfaction with the corresponding product-channel intersection.

Unsupervised Methodology—TF-IDF: For an unsupervised methodology, a standard weighting approach from natural language processing known as tf-idf may be applied to customer journeys. In this context, the individual interactions or events are the “terms” and a single customer's journey corresponds to a “document”. In an exemplary embodiment, a weight is computed for each event E for each customer C.

Term Frequency (tf): tf in the context of customer journeys is defined as the number of times an event has been observed for a particular customer in the collection considered above. More formally, it can be expressed as

$$tf ( {C}_{i} , {E}_{j} , T ) = \frac{{f}_{{C}_{i} , {E}_{j}}}{{\sum }_{E ∈ {C}_{i}} {f}_{E , {C}_{i ,}}} \qquad ( 1 )$$

where f_{Ci,Ej} is the raw count of a term in a document, i.e., the number of times that event occurs in journey Cᵢ.

Inverse Document Frequency (idf): In this context, idf is equivalent to a logarithm scaled inverse fraction of the customer journeys that contain the event. Mathematically, it can be expressed as follows:

$$idf ( C , {E}_{j} , T ) = log \frac{n}{\vert \{ {C}_{i} ∈ C : {E}_{j} ∈ {C}_{i} \} \vert ,} \qquad ( 2 )$$

Term Frequency-Inverse Document Frequency (tf-idf): The weight wᵢⱼ is given by tf-idf which is calculated as:

=tf-idf(Cᵢ,Eⱼ,C,T)=tf(Cᵢ,Eⱼ,T)·idf(C,Eⱼ,T) (3)

Once the weights have been computed, the weights are aggregated over products and channels, thus resulting in an interpretable embedding for each customer. FIG. 5 shows an example of an interpretable tf-idf embedding for a bank customer. These embeddings may then further calibrated by feeding them as feature inputs in a downstream operations model, as further described below.

Supervised Methodology Deep Learning: In the tf-idf approach, all events are weighted equally upon aggregation into product channel intersections. However, in some situations, certain events may be more important for a product channel intersection and should therefore be weighted higher. Although this can be achieved by taking a weighted average of event-wise tf-idf values, the weights would need to be defined manually using business logic.

In an exemplary embodiment, this problem may be solved by learning customer journey embeddings using neural networks by which these weights may be automatically computed. Two network architectures are proposed. For both architectures, the event term frequencies are used for each window as the input layer.

Dense Neural Network: The proposed ensemble method jointly learns multiple identical neural networks, one model per time window. The individual components in the ensemble follow the multilayer perceptron approach, which implements a feedforward artificial neural network (ANN) architecture consisting of multiple layers of perceptrons or dense nodes. Each neural network's input layer contains (N=number of events in the considered sentiment category) nodes indicating the term frequencies of negative events for the corresponding window. For example, if negative events are considered, the input layers may have 928 nodes. This may be followed by a dense hidden layer with 60 neurons. The hidden layer may be activated by using a Rectified Linear Unit (ReLu) that is responsible for transforming the summed weight of a layer's input into its output, thus resulting in an embedding for each time window. The outputs of the hidden layers from all networks are then stacked together and passed as an input to downstream prediction tasks. This can be done by adding a final output layer to the ensemble that has two nodes with a Sigmoid activating function. The input size of the final output layer is 180 (i.e., 60 neurons from each component's hidden layer).

Interpretable Neural Network: Since every node in the input layer is connected to every node in the hidden layer in the dense neural network method as described above, the product and channel semantics are lost. This may cause difficulty in interpreting the learned embeddings, especially for business use cases. In an exemplary embodiment, in order to solve this problem, sparse hidden layers encapsulating product channel context may be added. The proposed ensemble method here is very similar to the dense neural network method described above. The input layer per component is the same as defined above, but it is followed by a ReLu activated sparse hidden layer of 60 neurons indicating the intersections of 4 products and 15 channels as specified in Table 1 and Table 2. Because the hidden layer is sparse, each node in the input layer is only mapped to the node that corresponds to its product-channel intersection in the hidden layer. The output of this hidden layer can be defined as an interpretable embedding for the component's time window A second sparse ReLu activated hidden layer of 60 neurons may be used to merge the component wise embeddings into a single interpretable embedding which takes the outputs of the above hidden layers from each window's component. The input size of the second hidden layer is 180 (i.e., 60 neurons from each component's hidden layer). A final output layer with input size 60 is added to the ensemble that has two nodes with a Sigmoid activating function.

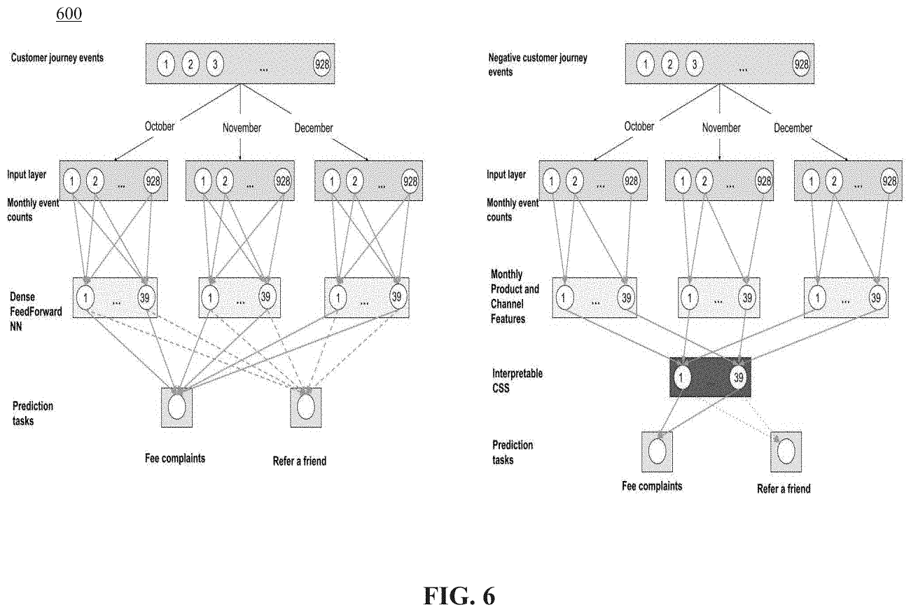

FIG. 6 is a graphical depiction 600 of a comparison between a windowing process as applied to a customer journey without interpretability, i.e., by using the dense neural network method as described above, and a windowing process as applied to a customer journey with interpretability, i.e., by using the interpretable neural network method as described above, according to an exemplary embodiment. In the windowing process as applied to a customer journey with interpretability, there is an Interpretable Cascading Style Sheets (CSS) stage that corresponds to the interpretability thereof.

Accordingly, with this technology, an optimized process for learning customer journey embeddings by which event sequences are analyzed for understanding and interpreting customer behavior is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a se of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fill within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating an interpretable embedding that corresponds to a sequence of events, the method being implemented by at least one processor, the method comprising:
receiving, by the at least one processor, information that corresponds to a plurality of events that respectively correspond to interactions between a customer and an organization;
determining, by the at least one processor for each respective event from among the plurality of events, a respective product associated with the organization that relates to the respective event and a respective channel associated with the organization via which the respective event has occurred;
assigning, by the at least one processor, a respective sentiment to each respective event from among the plurality of events;
computing, by the at least one processor, a respective weight for each respective event from among the plurality of events;
aggregating, by the at least one processor, the computed respective weights with respect to the determined products and the determined channels; and
using, by the at least one processor, the aggregated weights to generate the interpretable embedding for the customer.

2. The method of claim 1, further comprising generating a targeted offer to the customer based on the generated interpretable embedding.

3. The method of claim 1, wherein when at least one event from among the plurality of events includes a customer complaint, the method further comprises using the generated interpretable embedding to generate a response to the customer complaint.

4. The method of claim 1, wherein when at least two events from among the plurality of events include customer complaints, the method further comprises using the generated interpretable embedding to reduce a frequency of subsequent customer complaints.

5. The method of claim 1, wherein the assigning of a respective sentiment comprises tagging the respective event as being one from among a positive event, a negative event, and a neutral event.

6. The method of claim 5, wherein the assigning of the respective sentiment further comprises extracting at least one keyword from the respective event and comparing the extracted at least one keyword with each of a first list of keywords associated with a positive event, a second list of keywords associated with a negative event, and a third list of keywords associated with a neutral event.

7. The method of claim 1, wherein the computing of the respective weight comprises using a term frequency inverse document frequency (tf-idf) algorithm to compute the respective weight.

8. The method of claim 1, wherein the computing of the respective weight comprises using a feed-forward artificial neural network architecture that includes a plurality of perceptron layers to compute the respective weight.

9. The method of claim 8, wherein the computing of the respective weight further comprises adding at least one hidden layer that uses Rectified Linear Unit (ReLu) that indicates intersections of the determined products and the determined channels to the feed-forward artificial neural network.

10. A computing apparatus for generating an interpretable embedding that corresponds to a sequence of events, the computing apparatus comprising:
a processor;
a memory; and
a communication interface coupled to each of the processor and the memory, wherein the processor is configured to:
receive, via the communication interface, information that corresponds to a plurality of events that respectively correspond to interactions between a customer and an organization;
determine, for each respective event from among the plurality of events, a respective product associated with the organization that relates to the respective event and a respective channel associated with the organization via which the respective event has occurred;
assign a respective sentiment to each respective event from among the plurality of events;
compute a respective weight fro each respective event from among the plurality of events;
aggregate the computed respective weights with respect to the determined products and the determined channels; and
use the aggregated weights to generate the interpretable embedding for the customer.

11. The computing apparatus of claim 10, wherein the processor is further configured to generate a targeted offer to the customer based on the generated interpretable embedding.

12. The computing apparatus of claim 10, wherein when at least one event from among the plurality of events includes a customer complaint, the processor is further configured to use the generated interpretable embedding to generate a response to the customer complaint.

13. The computing apparatus of claim 10, wherein when at least two events from among the plurality of events include customer complaints, the processor is further configured to use the generated interpretable embedding to reduce a frequency of subsequent customer complaints.

14. The computing apparatus of claim 10, wherein the processor is further configured to assign the respective sentiment by tagging the respective event as being one from among a positive event, a negative event, and a neutral event.

15. The computing apparatus of claim 14, wherein the processor is further configured to extract at least one keyword from the respective event and compare the extracted at least one keyword with each of a first list of keywords associated with a positive event, a second list of keywords associated with a negative event, and a third list of keywords associated with a neutral event.

16. The computing apparatus of claim 10, wherein the processor is further configured to use a term frequency—inverse document frequency (tf-idf) algorithm to compute the respective weight.

17. The computing apparatus of claim 10, wherein the processor is further configured to use a feed-forward artificial neural network architecture that includes a plurality of perceptron layers to compute the respective weight.

18. The computing apparatus of claim 17, wherein the processor is further configured to add at least one hidden layer that uses Rectified Linear Unit (ReLu) that indicates intersections of the determined products and the determined channels to the feed-forward artificial neural network.

19. A non-transitory computer readable storage medium storing instructions for generating an interpretable embedding that corresponds to a sequence of events, the storage medium comprising executable code which, when executed by a processor, causes the processor to:
receive information that corresponds to a plurality of events that respectively, correspond to interactions between a customer and an organization;
determine, fix each respective event from among the plurality of events, a respective product associated with the organization that relates to the respective event and a respective channel associated with the organization via which the respective event has occurred;
assign a respective sentiment to each respective event from among the plurality of events;
compute a respective weight for each respective event from among the plurality of events;
aggregate the computed respective weights with respect to the determined products and the determined channels; and
use the aggregated weights to generate the interpretable embedding for the customer.

20. The storage medium of claim 19, wherein the executable code is further configured to cause the processor to assign a respective sentiment to each respective event by tagging the respective event as being one from among a positive event, a negative event, and a neutral event.
